(19) United States
(12) Patent Application Publication
(10) Pub. No.: US 2026/0274342 A1
(43) Pub. Date: Sep. 17, 2026

(54) VEHICLE BODY STRUCTURE

(71) Applicant: Honda Motor Co., Ltd., Tokyo (JP)

(72) Inventor: Kota FUJISAWA, Tokyo (JP)

(73) Assignee: Honda Motor Co., Ltd., Tokyo (JP)

(21) Appl. No.: 19/443,022

(22) Filed: Jan. 8, 2026

(30) Foreign Application Priority Data
Mar. 11, 2025 (CN) 202510285078.0

(51) Int. Cl. B62D 25/02

(52) U.S. Cl. CPC B62D 25/025

(57) ABSTRACT

A vehicle body structure includes: a side sill inner member, extending in a vehicle length direction, and provided with a fixing hole for mounting a belt or a hook to be fixed to a loaded object during loading and transportation; a side panel outer member, joined to the side sill inner member from an outer side in a vehicle width direction to form a side sill cross-section portion; and a support member, provided at an end portion of the side sill inner member corresponding to the side sill inner member, and having a support hole at a position corresponding to the fixing hole, in which the support member has a connecting surface portion extending from the end portion of the side sill inner member in the vehicle length direction and bent in a vehicle height direction, and the connecting surface portion is connected to the side panel outer member.

### CROSS-REFERENCE TO RELATED APPLICATION

This application claims the priority benefit of China application serial no. 202510285078.0, filed on March 11, 2025. The entirety of the above-mentioned patent application is hereby incorporated by reference herein and made a part of this specification.

### BACKGROUND

### Technical Field

The disclosure relates to a vehicle body structure.

### Description of Related Art

In recent years, efforts to provide access to sustainable transportation systems that also take into account vulnerable persons such as the elderly, the disabled, and children among traffic participants have been active. In order to achieve the stated purpose, research and development efforts are made to further improve the safety and convenience of transportation through developments related to collision safety performance.

In the prior art, Patent Document 1 (Japanese Patent Publication No. 10-226358) discloses a side sill structure in which a side sill inner member is joined to a side sill outer member, thereby closing a front end portion of the side sill structure into a bag shape. In addition, an opening is provided above the front end portion of the side sill structure and connected to a front pillar of a vehicle. However, the side sill structure of Patent Document 1 has a flange portion provided at the end portion of the side sill inner member in a manner bent substantially at a right angle and connected to other components. Since the flange portion is provided at the end portion of the side sill inner member, it is difficult to share the side sill inner member with vehicles having different overall vehicle lengths (i.e., wheelbases between the front and back wheels of the vehicle). In more detail, when a side sill inner member for a vehicle with a long wheelbase is applied to a vehicle with a short wheelbase, the end portion of the side sill inner member needs to be cut, thereby affecting the structural performance of the connection portion with other components and further affecting the formation of the load transfer path. Therefore, how to balance the versatility of the side sill inner member and the load transfer performance of the side sill structure is an issue that needs to be solved.

The disclosure aims to solve the above-mentioned problems and improve collision safety performance, so that it is beneficial to develop sustainable transportation systems.

### SUMMARY

The disclosure provides a vehicle body structure capable of achieving good load transfer performance.

According to an embodiment of the disclosure, a vehicle body structure includes: a side sill inner member, extending in a vehicle length direction, and provided with a fixing hole for mounting a belt or a hook to be fixed to a loaded object during loading and transportation; a side panel outer member, joined to the side sill inner member from an outer side in a vehicle width direction to form a side sill cross-section portion; and a support member, provided at an end portion of the side sill inner member corresponding to the side sill inner member, and having a support hole at a position corresponding to the fixing hole, in which the support member has a connecting surface portion extending from the end portion of the side sill inner member in the vehicle length direction and bent in a vehicle height direction, and the connecting surface portion is connected to the side panel outer member.

Based on the above, in the embodiment of the disclosure, the vehicle body structure is provided with the support member having sufficient strength and rigidity to withstand loading and transportation, and the support member provided corresponding to the side sill inner member is also connected to the side panel outer member through its connecting surface portion, so that when a collision load in the vehicle length direction is input to the side sill cross-section portion, the collision load can be transmitted from the side panel outer member to the side sill inner member through the connecting surface portion of the support member, thereby forming an effective load transfer path and suppressing deformation of the side sill cross-section portion. Furthermore, in the embodiment of the disclosure, for different vehicle types, the side sill inner member with different lengths in the vehicle length direction can be easily obtained by cutting the end portions of the side sill inner member, so that the forming mold for forming the side sill inner member can be shared among the different vehicle types, thereby reducing product manufacturing costs, without affecting the formation of the load transfer path. In this way, the side sill inner member of the vehicle body structure can have good versatility, and the vehicle body structure can also achieve good load transfer performance.

In order to make the above-mentioned features and advantages of the disclosure comprehensible, embodiments accompanied with drawings are described in detail below.

### BRIEF DESCRIPTION OF THE DRAWINGS

FIG. 1 is a schematic diagram of a vehicle body structure according to an embodiment of the disclosure.

FIG. 2 is a schematic perspective diagram of the vehicle body structure shown in FIG. 1 when viewed from below.

FIG. 3 and FIG. 4 are schematic diagrams of the components of the vehicle body structure shown in FIG. 1 and FIG. 2 with the side panel outer member removed.

FIG. 5 is a schematic cross-sectional view of the vehicle body structure shown in FIG. 2 along line A-A.

FIG. 6 and FIG. 7 are partial enlarged schematic diagrams of the vehicle body structure shown in FIG. 3 when viewed from different perspectives.

FIG. 8 is a schematic cross-sectional view of the vehicle body structure shown in FIG. 3 along line B-B.

FIG. 9 is a schematic cross-sectional view of the vehicle body structure shown in FIG. 3 along line C-C.

### DESCRIPTION OF THE EMBODIMENTS

In an embodiment of the disclosure, the vehicle body structure also includes: a wheel cover component, which forms at least a part of a wheel cover on an inner side of the side panel outer member in the vehicle width direction, in which the side panel outer member and the wheel cover component are connected in front of an opening portion of the side sill cross-section portion that opens in the vehicle length direction.

In an embodiment of the disclosure, a gap is provided at the end portion of the side sill inner member to separate the side sill inner member from the side panel outer member or the wheel cover component.

In an embodiment of the disclosure, an outer end portion of the side sill cross-section portion in the vehicle width direction is located on a side surface of the side panel outer member, and a lower surface of the side sill inner member extends to a portion of the side surface of the side panel outer member that constitutes the outer end portion of the side sill cross-section portion in the vehicle width direction.

In an embodiment of the disclosure, an abutting portion is provided on the side surface of the side panel outer member, the lower surface of the side sill inner member abuts against the abutting portion, and the abutting portion is located on an outside of the support member in the vehicle width direction.

In an embodiment of the disclosure, the side panel outer member is made of ultra-high strength steel plate.

In an embodiment of the disclosure, the support member is subjected to a flanging process to raise an edge of the support hole.

In an embodiment of the disclosure, the support member is made of ultra-high strength steel plate.

In an embodiment of the disclosure, the support member is provided at a position overlapping with a lifting bracket in the vehicle length direction when viewed from the side.

Reference will now be made in detail to the exemplary embodiments of the disclosure, and examples of the exemplary embodiments are illustrated in the accompanying drawings. Wherever possible, the same reference symbols are used in the drawings and descriptions to indicate the same or similar parts.

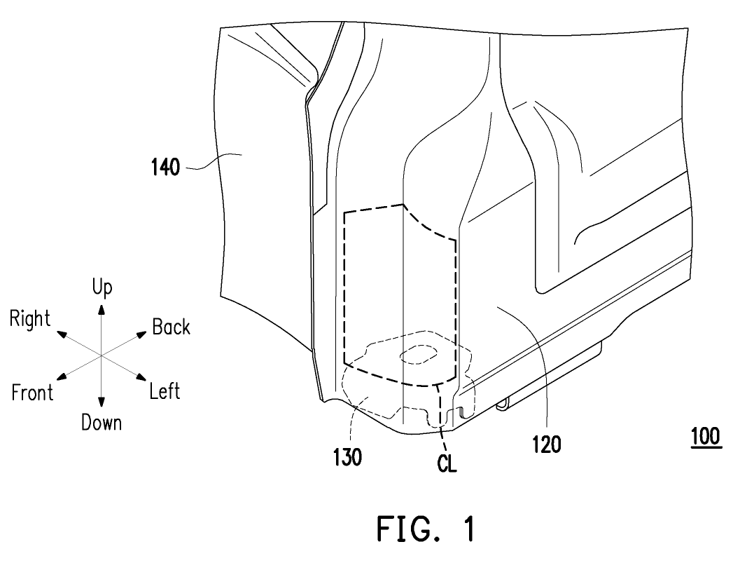

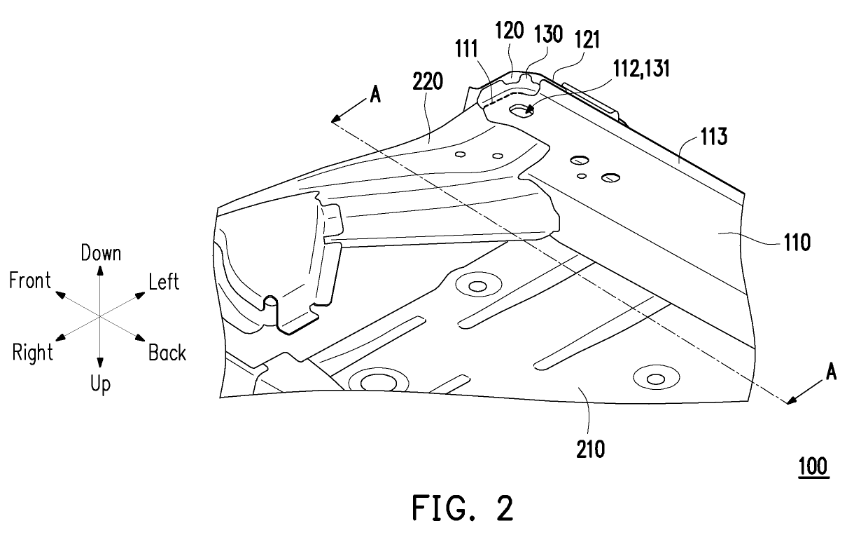

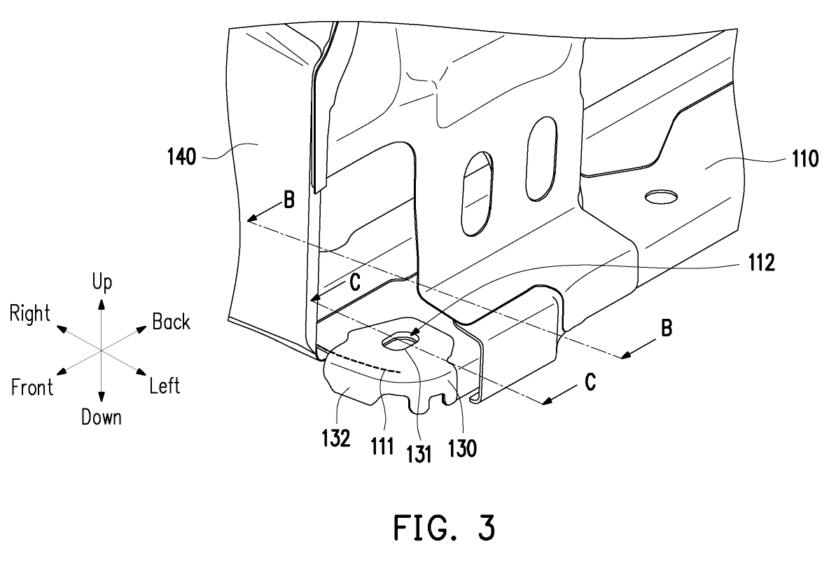

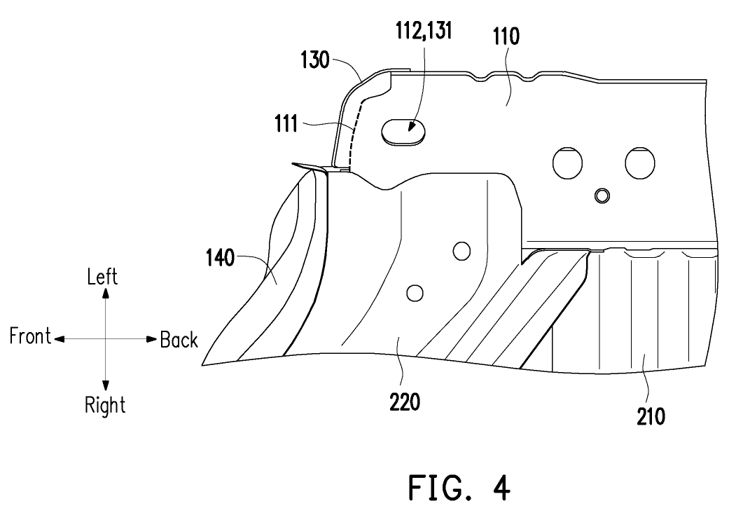

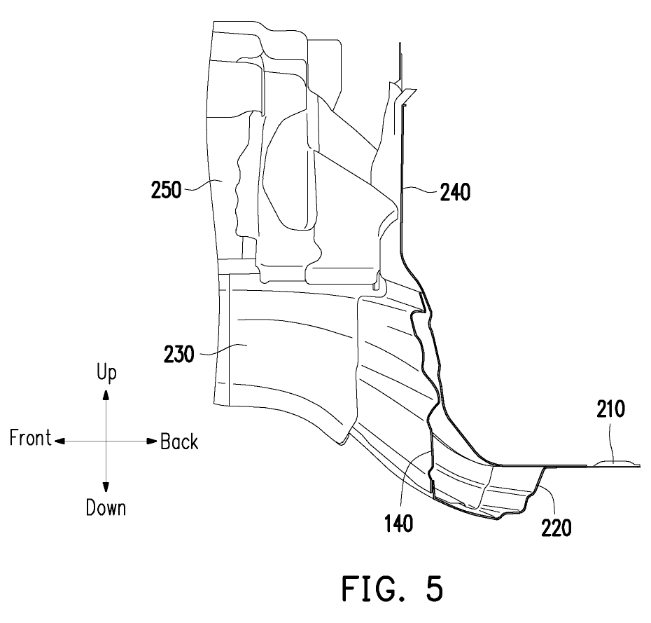

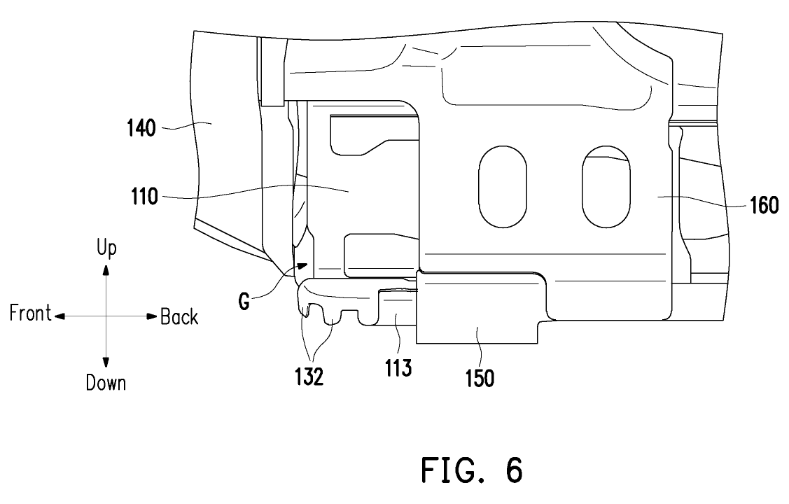

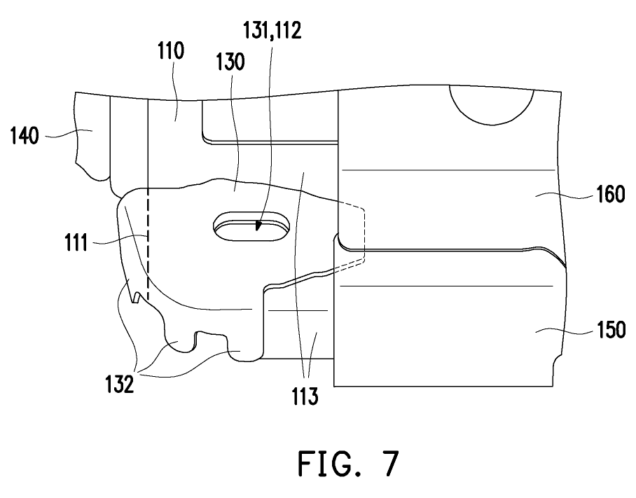

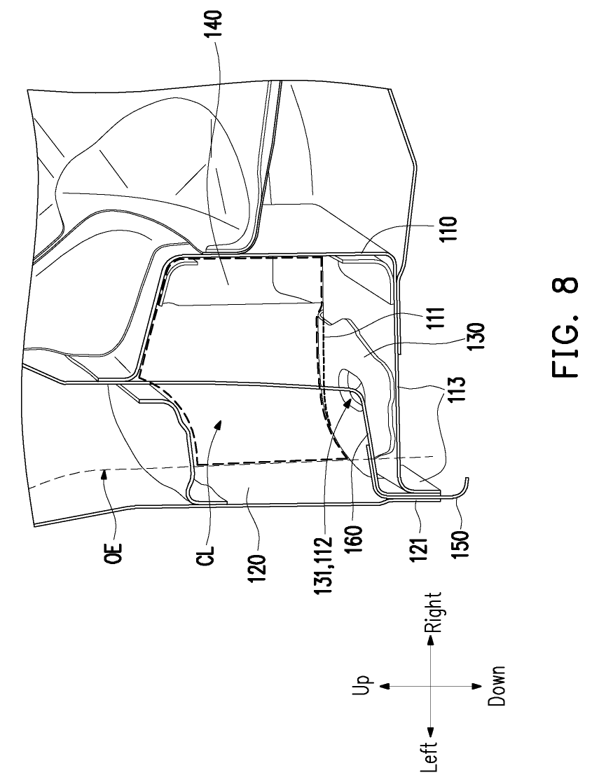

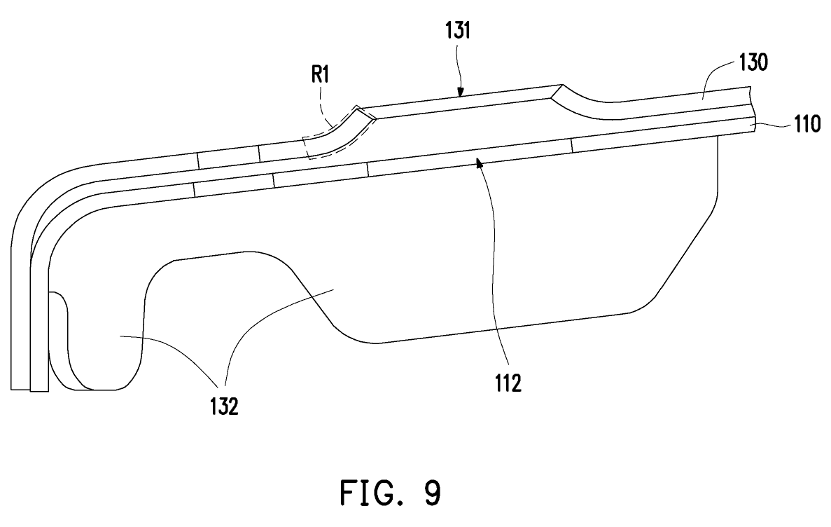

FIG. 1 is a schematic diagram of a vehicle body structure according to an embodiment of the disclosure. FIG. 2 is a schematic perspective diagram of the vehicle body structure shown in FIG. 1 when viewed from below. FIG. 3 and FIG. 4 are schematic diagrams of the components of the vehicle body structure shown in FIG. 1 and FIG. 2 with the side panel outer member removed. FIG. 5 is a schematic cross-sectional view of the vehicle body structure shown in FIG. 2 along line A-A. FIG. 6 and FIG. 7 are partial enlarged schematic diagrams of the vehicle body structure shown in FIG. 3 when viewed from different perspectives. FIG. 8 is a schematic cross-sectional view of the vehicle body structure shown in FIG. 3 along line B-B. FIG. 9 is a schematic cross-sectional view of the vehicle body structure shown in FIG. 3 along line C-C. It should be noted that, for the sake of convenience, the front and back directions, left and right directions, and up and down directions of the vehicle are defined as shown in the figure, and the composition of each part is explained according to this definition. The front and back directions, left and right directions, and up and down directions of the vehicle are equivalent to the vehicle length direction, vehicle width direction, and vehicle height direction, respectively.

Referring to FIG. 1 and FIG. 3, in the embodiment, a vehicle body structure 100 includes a side sill inner member 110, a side panel outer member 120, and a support member 130. The side sill inner member 110 extends in the vehicle length direction and is provided with a fixing hole 112 for mounting a belt or a hook to be fixed to the loaded object during loading and transportation. The side panel outer member 120 is joined to the side sill inner member 110 from the outer side in the vehicle width direction to form a side sill cross-section portion CL. The support member 130 is provided at an end portion 111 of the side sill inner member 110 corresponding to the side sill inner member 110, and has a support hole 131 at a position corresponding to the fixing hole 112. The support member 130 includes a connecting surface portion 132 extending from the end portion 111 of the side sill inner member 110 in the vehicle length direction and bent in the vehicle height direction. The connecting surface portion 132 is connected to the side panel outer member 120.

In this way, the vehicle body structure 100 is provided with the support member 130 having sufficient strength and rigidity to withstand loading and transportation, and the support member 130 provided corresponding to the side sill inner member 110 is also connected to the side panel outer member 120 through its connecting surface portion 132, so that when a collision load in the vehicle length direction is input to the side sill cross-section portion CL, the collision load can be transmitted from the side panel outer member 120 to the side sill inner member 110 through the connecting surface portion 132 of the support member 130, thereby forming an effective load transfer path and suppressing deformation of the side sill cross-section portion CL.

In addition, as shown in FIG. 2 to FIG. 5, in the embodiment, the vehicle body structure 100 further includes a wheel cover component 140, a floor panel 210, an outer tilt frame 220, a lifting bracket 150, a reinforcement member 160, a side frame 230, a dashboard lower panel 240, and a shock absorber housing 250. As shown in FIG. 5, in the embodiment, the floor panel 210 and the dashboard lower panel 240 separate the interior area and exterior area of the vehicle cabin of the vehicle body structure 100. The shock absorber housing 250 and the side frame 230 are located in the front compartment of the exterior area and connected to each other. The side frame 230 extends in the vehicle length direction in the front compartment of the exterior area and is connected to the wheel cover component 140. Referring to FIG. 2, FIG. 4, and FIG. 5, the wheel cover component 140 is connected to the outer tilt frame 220, and the outer tilt frame 220 extends in the vehicle length direction and is connected to the floor panel 210. In this way, when a collision occurs and the vehicle body structure 100 receives a collision load in the vehicle length direction, the collision load can be transmitted from the shock absorber housing 250, the side frame 230, the wheel cover component 140, and the outer tilt frame 220 to the floor panel 210, thereby forming an effective load transfer path and effectively dispersing the collision load.

On the other hand, referring to FIG. 1 and FIG. 3 again, in the embodiment, the wheel cover component 140 forms at least a portion of the wheel cover on the inner side of the side panel outer member 120 in the vehicle width direction, and the side panel outer member 120 and the wheel cover component 140 are connected in front of the opening portion of the side sill cross-section portion CL that opens in the vehicle length direction. In this way, since the vehicle body structure 100 connects the side panel outer member 120 and the wheel cover component 140 at the front of the opening of the side sill cross-section portion CL, when the vehicle collides and receives a collision load in the vehicle length direction, causing the tire to move and hit the wheel cover component 140, the collision load may pass through the wheel cover component 140, the side panel outer member 120, the support member 130, and the side sill inner member 110 in sequence, such that the collision load caused by the movement of the tire can be transmitted to the side sill cross-section portion CL through the support member 130.

Furthermore, as shown in FIG. 6, in the embodiment, a gap G is provided at the end portion 111 of the side sill inner member 110 to separate the side sill inner member 110 from the side panel outer member 120 or the wheel cover component 140. Thus, since the side sill inner member 110 and the wheel cover component 140 (or the side panel outer member 120) have a gap G at the end portion 111 of the side sill inner member 110 to separate them from each other, a structure that is separated and not connected can be formed. Therefore, when the collision load is transmitted to the side sill cross-section portion CL, the energy is first transferred only from the wheel cover component 140 (or the side panel outer member 120 ) to the area reinforced with the support member 130 in the side sill cross-section portion CL.

Thus, in the embodiment, by arranging the end portion 111 of the side sill inner member 110 to overlap with the support member 130, an effective load transfer path can be formed, and when the side sill inner member 110 has a gap G between the end portion 111 and the side panel outer member 120 to separate them from each other, a structure that is separated and not connected can be formed. Therefore, for different vehicle types, it is possible to obtain the side sill inner member 110 with different lengths in the vehicle length direction by cutting the end portion 111 of the side sill inner member 110, so that different vehicle models can also share the forming mold for forming the side sill inner member 110, thereby reducing product manufacturing costs, without affecting the formation of the load transfer path or the connection with other components. In this way, the side sill inner member 110 of the vehicle body structure 100 can have good versatility, and the vehicle body structure 100 can also achieve good load transfer performance.

Furthermore, in the embodiment, the side panel outer member 120 and the support member 130 are made of ultra-high strength steel plates. For example, ultra-high strength steel plates are ultra-high tension steel plates with high strength and high rigidity, and have a tensile strength of 1000 MPa when both cold pressing and hot pressing are performed. Thus, in the embodiment, since the side panel outer member 120 is made of ultra-high strength steel plate, it has sufficient strength and does not need to be provided with a side sill outer member constituting the vehicle frame. Compared with the prior art in which a side panel outer member made of a thin mild steel plate is combined with a side sill outer member of a vehicle frame made of a thick high-tensile steel plate to form a side sill cross-section portion, the vehicle body structure 100 of the embodiment can reduce the number of parts. On the other hand, in the embodiment, since the support member 130 is also made of ultra-high strength steel plate, when a head-on collision occurs, the load can be effectively transmitted through the reinforcement of the support member 130 with high strength and rigidity, thereby suppressing the deformation of the side sill cross-section portion CL.

Furthermore, as shown in FIG. 7, in the embodiment, the support member 130 is provided at a position overlapping with the lifting bracket 150 in the vehicle length direction when viewed from the side. The lifting bracket 150 has strength and rigidity to support and fix the vehicle when the vehicle is jacked up, and is positioned to overlap with the support member 130 in the vehicle length direction. In this way, when a head-on collision occurs on the vehicle, the collision load input from the side panel outer member 120 to the support member 130 can also be transmitted to the side sill inner member 110 through the lifting bracket 150 having high strength and rigidity.

Referring to FIG. 3 and FIG. 8, in the embodiment, an outer end portion OE of the side sill cross-section portion CL in the vehicle width direction is located on the side surface of the side panel outer member 120, and a lower surface 113 of the side sill inner member 110 extends to the portion of the side surface of the side panel outer member 120 that constitutes the outer end portion OE of the side sill cross-section portion CL in the vehicle width direction. Thus, since the lower surface 113 of the side sill inner member 110 extends to the portion of the side surface of the side panel outer member 120 constituting the outer end portion OE of the side sill cross-section portion CL in the vehicle width direction, the entire lower area of the side sill cross-section portion CL is composed of the side sill inner member 110, and no components such as the side sill outer member of the prior art are provided. Therefore, when the support member 130 is disposed on the lower surface 113 of the side sill inner member 110, the lower surface 113 of the side sill inner member 110, which is the entire lower portion of the side sill cross-section portion CL, can be used as the area where the support member 130 is disposed. Referring to FIG. 3 and FIG. 8 , in the embodiment, the side panel outer member 120 has an abutting portion 121 on its side surface, the lower surface 113 of the side sill inner member 110 abuts against the abutting portion 121, and the abutting portion 121 is located on the outer side of the support member 130 in the vehicle width direction. As such, since the abutting portion 121 serving as the joint between the side panel outer member 120 and the side sill inner member 110 is located on the outside of the support member 130 in the vehicle width direction, the arrangement area of the support member 130 and its fixing hole 112 is not restricted. Thus, in the embodiment, the arrangement area of the support member 130 has a good degree of freedom and can be configured according to actual needs.

Furthermore, as shown in FIG. 9, in the embodiment, the support member 130 is subjected to a flanging process (also referred to as flange processing) to raise the edge of the support hole 131, so as to form a protrusion (i.e., a flanging portion R1) around the support hole 131. In this way, by flanging the support hole 131 of the support member 130, the strength and rigidity can be improved, which helps prevent damage to the support hole 131 during loading and transportation, and further improves the load transfer performance of the support member 130.

In summary, in the embodiment of the disclosure, the vehicle body structure is provided with the support member having sufficient strength and rigidity to withstand loading and transportation, and the support member provided corresponding to the side sill inner member is also connected to the side panel outer member through its connecting surface portion, so that when a collision load in the vehicle length direction is input to the side sill cross-section portion, the collision load can be transmitted from the side panel outer member to the side sill inner member through the connecting surface portion of the support member, thereby forming an effective load transfer path and suppressing deformation of the side sill cross-section portion. Furthermore, in the embodiment of the disclosure, for different vehicle types, the side sill inner member with different lengths in the vehicle length direction can be easily obtained by cutting the end portions of the side sill inner member, so that the forming mold for forming the side sill inner member can be shared among different vehicle types, thereby reducing product manufacturing costs without affecting the formation of the load transfer path. In this way, the side sill inner member of the vehicle body structure can have good versatility, and the vehicle body structure can also achieve good load transfer performance.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments can still be modified, or parts or all of the technical features thereof can be equivalently replaced; however, these modifications or substitutions do not deviate the essence of the corresponding technical solutions from the scope of the technical solutions of the embodiments of the disclosure.

What is claimed is:

1. A vehicle body structure, comprising:
a side sill inner member, extending in a vehicle length direction, and provided with a fixing hole for mounting a belt or a hook to be fixed to a loaded object during loading and transportation;
a side panel outer member, joined to the side sill inner member from an outer side in a vehicle width direction to form a side sill cross-section portion; and
a support member, provided at an end portion of the side sill inner member corresponding to the side sill inner member, and having a support hole at a position corresponding to the fixing hole, wherein the support member has a connecting surface portion extending from the end portion of the side sill inner member in the vehicle length direction and bent in a vehicle height direction, and the connecting surface portion is connected to the side panel outer member.

2. The vehicle body structure according to claim 1, further comprising:
a wheel cover component, forming at least a part of a wheel cover on an inner side of the side panel outer member in the vehicle width direction,
wherein the side panel outer member and the wheel cover component are connected in front of an opening portion of the side sill cross-section portion that opens in the vehicle length direction.

3. The vehicle body structure according to claim 2, wherein a gap is provided at the end portion of the side sill inner member to separate the side sill inner member from the side panel outer member or the wheel cover component.

4. The vehicle body structure according to claim 1, wherein an outer end portion of the side sill cross-section portion in the vehicle width direction is located on a side surface of the side panel outer member, and a lower surface of the side sill inner member extends to a portion of the side surface of the side panel outer member that constitutes the outer end portion of the side sill cross-section portion in the vehicle width direction.

5. The vehicle body structure according to claim 4, wherein an abutting portion is provided on the side surface of the side panel outer member, the lower surface of the side sill inner member abuts against the abutting portion, and the abutting portion is located on an outside of the support member in the vehicle width direction.

6. The vehicle body structure according to claim 1, wherein the side panel outer member is made of ultra-high strength steel plate.

7. The vehicle body structure according to claim 1, wherein the support member is subjected to a flanging process to raise an edge of the support hole.

8. The vehicle body structure according to claim 7, wherein the support member is made of ultra-high strength steel plate.

9. The vehicle body structure according to claim 1, wherein the support member is provided at a position overlapping with a lifting bracket in the vehicle length direction when viewed from the side.
